(19) United States
(12) Patent Application Publication
(10) Pub. No.: US 2019/0387408 A1
(43) Pub. Date: Dec. 19, 2019

(54) WIRELESS ACCESS NODE DETECTING METHOD, WIRELESS NETWORK DETECTING SYSTEM AND SERVER

(71) Applicant: BEIJING QIHOO TECHNOLOGY COMPANY LIMITED, Beijing (CN)

(72) Inventor: Qing YANG, Beijing (CN)

(21) Appl. No.: 15/533,291

(22) PCT Filed: Nov. 13, 2015
(86) PCT No.: PCT/CN2015/094622

§ 371 Date: Sep. 5, 2017

(30) Foreign Application Priority Data
Dec. 3, 2014 (CN) 201410727915.2

(51) Int. Cl. H04W 12/12; H04W 16/18; H04W 12/00; H04W 8/00; H04L 29/06; H04W 12/08

(52) U.S. Cl. CPC H04W 12/1202; H04W 16/18; H04W 12/00512; H04W 12/08; H04W 12/00506; H04W 8/005; H04L 63/20; H04W 12/00505

(57) ABSTRACT

This invention discloses a wireless access node detecting method, a wireless network detecting system and a server. The server comprises: a receiving unit configured to receive a wireless network signal sent by a wireless network sensor, of which the wireless network signal is a wireless network signal received by the wireless network sensor within a coverage area; a parsing unit configured to parse out wireless network connection information comprising wireless access node information from the wireless network signal; and an analyzing unit configured to analyze the wireless access node information in the wireless network connection information, and generate an analysis result. By receiving wireless access node information within a monitoring area sent by multiple wireless network sensors disposed therein, analyzing it and conducting access control, the server can effectively ensure the security of a wireless network within an enterprise.

### FIELD OF THE INVENTION

The invention relates to the network security technology, and in particular, to a wireless access node detecting method, a wireless network detecting system and a server.

### BACKGROUND OF THE INVENTION

As the network scale continues to expand and the types of network applications continue to grow, in comparison with a wired network, a wireless network has the features of convenient installation, flexible use, easy to expand, and so on, and therefore, whether enterprises, or schools, or hospitals, or government agencies, or the like, have deployed a lot of wireless networks to support their applications of information management, communications, emails, office, etc. For a traditional wired network, convenient network control may be conducted by deploying a network firewall to achieve real-time security protection for an internal network of an enterprise, as shown in FIG. 1.

While the wireless network brings about flexibility, network security issues become increasingly prominent. As one of currently predominant active network security measures, network intrusion detection effectively supplements and perfects a security measure such as access control, data encryption, firewall, virus prevention, etc. and improves the integrity of the information security infrastructure by identifying and responding to a malicious network connection on a computer and a network resource, and has already become an indispensable part of an information system security solution.

However, the network intrusion detection can not detect a device of a wireless network card outside a firewall. For example, it is especially easy for a smart phone, a tablet computer and a notebook computer with a built-in 3G wireless network card to have the mobile frequency become a threatened target of data leakage and targeted attack in an enterprise. For instance, a notebook computer of a company is equipped with a mobile wireless network card, and the notebook computer is brought into the work area, then connected to an expansion port and thereby connected to the network of the company. At this point, the used wireless network card can bypass the security control of the company.

Thereby, the enterprise wireless network security faces with another kind of challenge, and how to regulate a wireless access node built by an employee privately becomes a technical problem that needs to be solved presently.

### SUMMARY OF THE INVENTION

In view of the above problems, the invention is proposed to provide a wireless access node detecting method, a wireless network detecting system and a server, which overcome the above problem or at least in part solve or mitigate the above problem.

According to an aspect of the invention, there is provided a server comprising:

a receiving unit configured to receive a wireless network signal sent by a wireless network sensor, which wireless network signal is a wireless network signal received by the wireless network sensor within a coverage area;

a parsing unit configured to parse out wireless network connection information comprising wireless access node information from the wireless network signal; and

an analyzing unit configured to analyze the wireless access node information in the wireless network connection information, and generate an analysis result.

According to another aspect of the invention, there is provided a wireless network sensor comprising:

a receiving unit configured to receive a wireless network signal within a coverage area; and

a sending unit configured to send the received wireless network signal to a server, such that the sever parses out wireless network connection information from the wireless network signal and analyzes wireless network access node information in the wireless network connection information.

According to a further aspect of the invention, there is provided a wireless access node detecting method comprising:

a server receiving a wireless network signal sent by a wireless network sensor, of which the wireless network signal is a wireless network signal received by the wireless network sensor within a coverage area;

parsing out wireless network connection information comprising wireless access node information from the wireless network signal; and

the server analyzing the wireless access node information in the wireless network connection information, and generating an analysis result.

According to a further aspect of the invention, there is provided a wireless access node detecting method comprising:

a wireless network sensor receiving a wireless network signal within a coverage area, and sending the received wireless network signal to a server, such that the sever parses out wireless network connection information from the wireless network signal and analyzes wireless network access node information in the wireless network connection information.

According to a further aspect of the invention, there is provided a wireless network detecting system comprising:

at least one wireless network sensor configured to receive a wireless network signal within its coverage area, wherein at least one wireless network card is built in the wireless network sensor; and

a server coupled to the wireless network sensor and configured to receive a wireless network signal from the wireless network sensor and parse out wireless network connection information from the wireless network signal, wherein the wireless network connection information comprises information of a wireless access node;

wherein the server is further configured to conduct analysis on the wireless access node and generate an analysis result.

According to yet another aspect of the invention, there is provided a computer program comprising a computer readable code which causes a computing device to perform the wireless access node detecting method described above, when said computer readable code is running on the computing device.

According to still another aspect of the invention, there is provided a computer readable medium storing therein the computer program as described above.

The beneficial effects of the invention lie in that:

in the wireless access node detecting method, the wireless network detecting system and the server provided by the invention, by receiving wireless access node information sent by multiple wireless network sensors disposed within a monitoring area, and conducting security analysis to the wireless access node information monitored by the wireless network sensors according to whitelist wireless access nodes, the server timely finds a wireless access node that has an attack behavior or is built privately, and ensures the security of a wireless network within an enterprise.

The above description is merely an overview of the technical solutions of the invention. In the following particular embodiments of the invention will be illustrated in order that the technical means of the invention can be more clearly understood and thus may be embodied according to the content of the specification, and that the foregoing and other objects, features and advantages of the invention can be more apparent.

### BRIEF DESCRIPTION OF THE DRAWINGS

Various other advantages and benefits will become apparent to those of ordinary skills in the art by reading the following detailed description of the preferred embodiments. The drawings are only for the purpose of showing the preferred embodiments, and are not considered to be limiting to the invention. And throughout the drawings, like reference signs are used to denote like components. In the drawings:

FIG. 1 shows schematically a schematic diagram of a network security structure in the prior art;

FIG. 2 shows schematically a structure diagram of a server according to an embodiment of the invention;

FIG. 3 shows schematically a distribution diagram of wireless network sensors in a wireless network detecting system according to an embodiment of the invention;

FIG. 4 shows schematically an analysis diagram of wireless access nodes according to an embodiment of the invention;

FIG. 5A and FIG. 5B show schematically an analysis diagram of security levels of trusted wireless access nodes according to an embodiment of the invention;

FIG. 5C and FIG. 5D show schematically a schematic diagram of data analysis of wireless access nodes according to an embodiment of the invention;

FIG. 5E and FIG. 5F show schematically a schematic diagram of a WEB management platform according to an embodiment of the invention;

FIG. 6 shows schematically a structure diagram of a wireless network sensor according to an embodiment of the invention;

FIG. 7 shows schematically a flow diagram of a wireless access node detecting method according to an embodiment of the invention;

FIG. 8A shows schematically a schematic diagram of a wireless access node according to an embodiment of the invention;

FIG. 8B shows schematically a schematic diagram of a list of wireless access nodes within an area searched out by a client according to an embodiment of the invention;

FIG. 9 shows schematically a flow diagram of a wireless access node detecting method according to an embodiment of the invention;

FIG. 10 shows schematically a flow diagram of a wireless access node detecting method according to an embodiment of the invention;

FIG. 11 shows schematically a flow diagram of a wireless access node detecting method according to an embodiment of the invention;

FIG. 12 shows schematically a structure diagram of a wireless network detecting system according to an embodiment of the invention;

FIG. 13 shows schematically a block diagram of a computing device for performing a wireless access node detecting method according to the invention; and

FIG. 14 shows schematically a storage unit for retaining or carrying a program code implementing a wireless access node detecting method according to the invention.

### DETAILED DESCRIPTION OF THE INVENTION

In the following the invention will be further described in conjunction with the drawings and the particular embodiments. The following embodiments are used only for more clearly illustrating the technical solutions of the invention, which can not be used to limit the protection scope of the invention.

In the following, part of the words mentioned in embodiments of the invention will be described by way of example.

The client mentioned in embodiments of the invention may refer to a device connected to a certain wireless access node. For example, it may be any device capable of wireless fidelity, such as a mobile phone, a computer, a tablet, a smart television, etc.

The wireless access node mentioned in embodiments of the invention may specifically be any device capable of generating a wireless signal. For example, the wireless access node may comprise a wireless access node, a wireless router, etc. of a portable wireless local area network (WLAN for short) established using a mobile phone. The wireless access node in embodiments of the invention comprises a wireless network access point (AP for short). An AP may be a wireless switch in a wireless network, which belongs to an access point for a mobile terminal to enter a wired network.

The whitelist wireless access nodes in embodiments of the invention may be a collection of trusted wireless access nodes, or a wireless access node self-established inside an enterprise for employees to surf the internet as well as a wireless access node trusted by the enterprise, or the like.

In the embodiments of the invention, all of the wireless access nodes that do not belong to the whitelist wireless access nodes belong to blacklist wireless access nodes.

Wireless fidelity (WIFI for short) is a short range wireless transmission technique, which can support a radio signal of internet access in the range of several hundreds of feet.

Nowadays, a wireless network attack is mainly to obtain important information such as confidential data, etc. inside a place such as an enterprise, etc. by way of access to a wireless access node via WIFI.

To this end, embodiments of the invention provide a wireless access node detecting method and a wireless network detecting system for monitoring a wireless access node in a wireless network inside an enterprise and ensuring the security of the network within the enterprise.

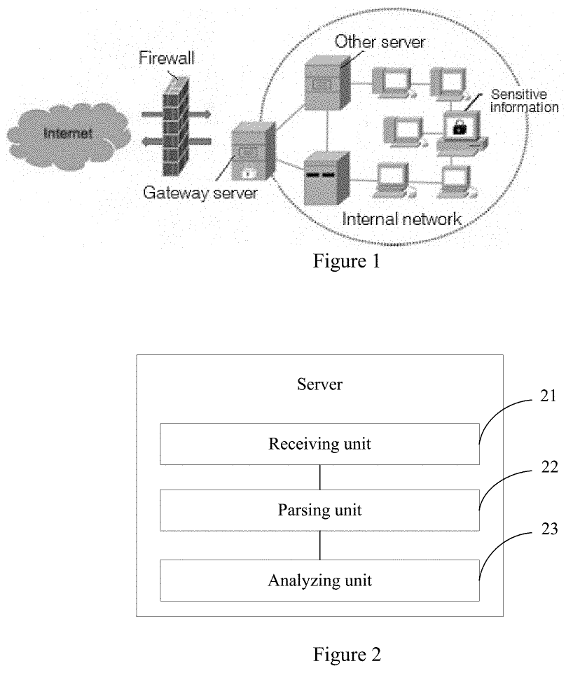

FIG. 2 shows a structure diagram of a server provided by an embodiment of the invention. As shown in FIG. 2, the server in this embodiment may comprise at least a receiving unit 21, a parsing unit 22, and an analyzing unit 23;

wherein the receiving unit 21 is configured to receive a wireless network signal sent by a wireless network sensor, which wireless network signal is a wireless network signal received by the wireless network sensor within a coverage area; the parsing unit 22 is configured to parse out wireless network connection information comprising wireless access node information from the wireless network signal; and the analyzing unit 23 is configured to analyze the wireless access node information in the wireless network connection information, and generate an analysis result.

Optionally, the receiving unit 21 is specifically configured to receive the wireless network signal sent by the wireless network sensor and location information of the wireless network sensor; and the location information of the wireless network sensor is location information preset in the wireless network sensor.

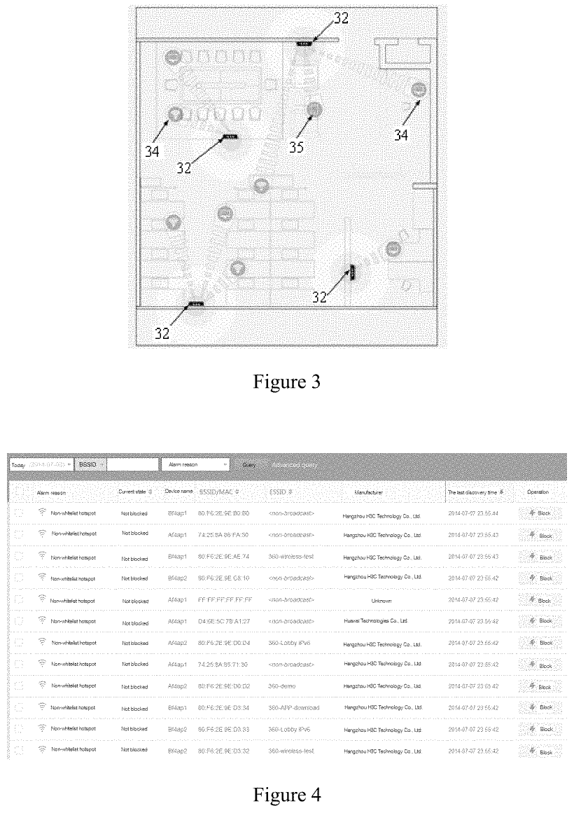

As an example, as shown in FIG. 3, the location of the wireless network sensor may specifically be arranged at each corner of an office area, specifically may be arranged at a location which will not affect the work of an employee and is at an appropriate distance from the employee. Specifically, a corresponding number of wireless network sensors are arranged according to the area of the office area, such as the locations of the wireless network sensors 32 as shown in FIG. 3.

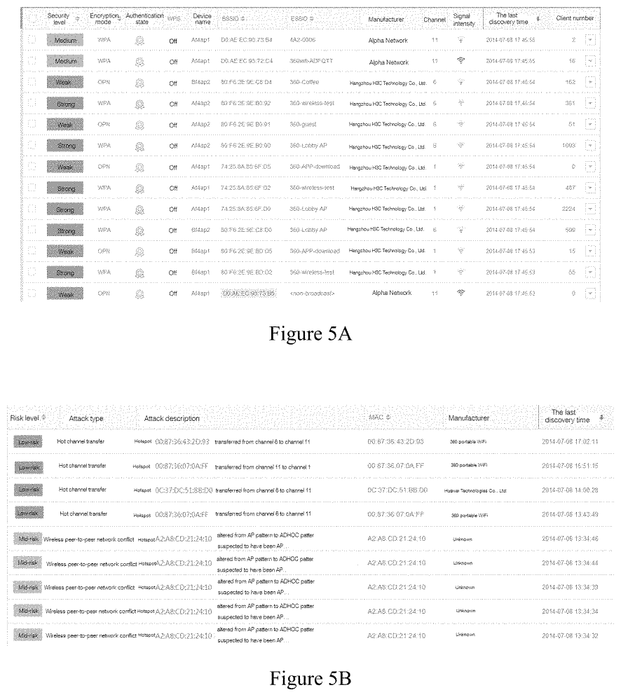

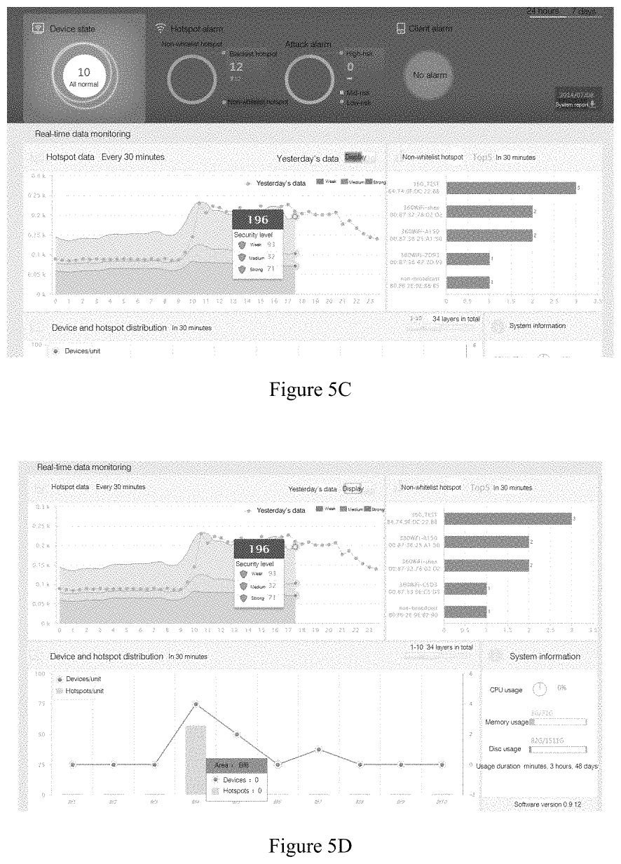

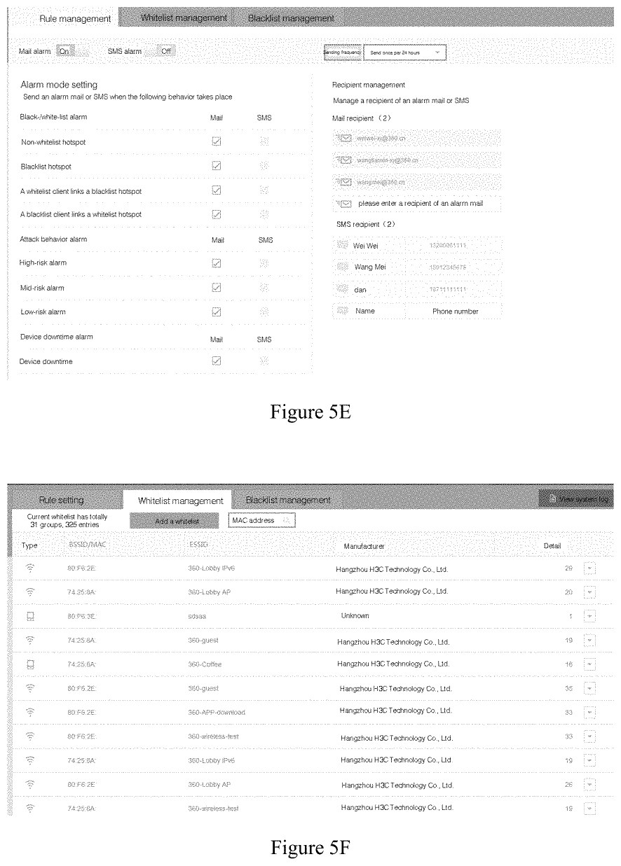

The analyzing unit 23 is specifically configured to analyze the wireless access node information in the wireless network connection information according to the location information, and generate an analysis result (as shown in FIG. 5D), in which the specific location of a wireless access node is comprised.

In another optional scenario, the analyzing unit 23 is further configured to analyze the wireless access node information in the wireless network connection information according to a preset black-/white-list rule, and generate an analysis result (as shown in FIG. 5C).

In particular, a wireless access node in the wireless access node information may be information of a wireless access node once connected by a client, or information of a wireless access node belongs to wireless access nodes in a preset blacklist/whitelist in the server.

In a specific application, in the server are stored a blacklist/whitelist of wireless access nodes within the coverage area, and a blacklist/whitelist rule. For a new wireless access hotspot, an administrator may add it to the blacklist or the whitelist manually at the server side, or also the server may automatically add the wireless access hotspot to the blacklist/whitelist according to the preset blacklist/whitelist rule stored in the server; in addition, the server may further customize the preset blacklist/whitelist rule as needed, and by default, a new wireless access node is black, and only wireless access node information that meets certain rules can be added to the whitelist.

In a further optional scenario, the analyzing unit 23 is further configured to conduct a security assessment to wireless access node information belonging to the preset whitelist in the server according to a preset risk assessment mechanism, and determine the security level of a wireless access node corresponding to the wireless access node information.

In particular, the server further comprises a sending unit 24 not shown in the figure. The sending unit 24 is configured to send alarm information when the security level of the wireless access node assessed by the analyzing unit is below a preset security level.

As an example, the sending unit 24 is specifically configured to send the alarm information to a third-party server/terminal where the administrator resides, or send the alarm information to a third-party server/terminal where a wireless access node corresponding to the wireless access node identifier is located, or send the alarm information to a third-party server/terminal where the administrator resides using an e-mail/short message, or send the alarm information to a third-party server/terminal where a wireless access node corresponding to the wireless access node identifier is located using an e-mail/short message.

In this embodiment, the wireless access node information may comprise a wireless access node name, a wireless access node identifier, i.e., media access control (MAC for short) address, a wireless access node manufacturer, a service set identifier (SSID for short), a wireless access node encryption mode, a wireless access node authentication mode, whether authentication is turned on, whether the WiFi protected setup (WPS for short) function is turned off, a wireless access node channel, wireless access node latest discovery time, and information of a client connected to the wireless access node, etc. The embodiment will only exemplify the wireless access node information, and will not define the content of the wireless access node information.

The information of a client comprises: a client identifier, a client manufacturer, a client number, time when a client is last connected to a wireless access node, and a list of wireless access nodes to which the client was connected.

Therein, the wireless access node name may be the name of a wireless access node searched out by a client or the name of a wireless access node monitored by a wireless network sensor; the wireless access node MAC address is the unique identifier of a wireless access node device; the wireless access node manufacturer may be the name of the manufacturer of a wireless access node, which is generally identified by the first 6 bits of the wireless access node MAC address; the wireless access node channel may be a channel where a wireless access node is located; and the wireless access node latest discovery time may be the time when a wireless access node was last discovered, and is used for detecting the presence of a wireless signal.

In an optional implementation scenario, the sending unit 24 may be configured to, when it is determined that a wireless access node corresponding to the wireless access node identifier does not belong to the whitelist wireless access nodes, send to the wireless network sensor instruction information for blocking all clients connected to the wireless access node, such that the wireless network sensor blocks connections of the wireless access node and all the clients of the wireless access node according to the instruction information;

or, the sending unit 24 is configured to, when it is determined that a wireless access node corresponding to the wireless access node identifier does not belong to the whitelist wireless access nodes, send to a third-party server to which the wireless access node belongs instruction information for turning off the wireless access node, such that the third-party server turns off the wireless access node.

Optionally, the sending unit 24 may be further configured to, when it is determined that a wireless access node corresponding to the wireless access node identifier does not belong to the whitelist wireless access nodes, send alarm information.

In addition, it may be noted that, the server in this embodiment may further analyze a wireless access node in the blacklist wireless access nodes and obtain an analysis result, as shown in FIG. 4.

In general, in a specific application, after receiving a wireless network signal comprising wireless access node information sent by a wireless network sensor, the server may determine whether a wireless access node corresponding to the wireless access node information is a trusted wireless access node according to the whitelist, and if it belongs to trusted wireless access nodes, that is, belongs to the whitelist, may further determine the security level of the trusted wireless access node using the risk assessment mechanism, and show the security level/risk level of the trusted wireless access node to the administrator by a management platform, as shown in FIG. 5A and FIG. 5B.

Additionally, if it is determined that a wireless access node corresponding to the wireless access node information belongs to the blacklist, it may be possible to analyze all wireless access nodes which belong to the blacklist in a time period, as shown in FIG. 4, and determine information such as an intrusion time period, intrusion location, etc.

Further, the server is also configured to analyze wireless access nodes corresponding to all wireless access node information monitored by the wireless network sensor in a certain time period (e.g., time of a day or 10 hours, a week, etc.), and generate an analysis result, as shown in FIG. 5C and FIG. 5D, which is provided to the administrator by the management platform.

The server in this embodiment is further configured to store the wireless access node information sent by the wireless network sensor for real-time query and real-time analysis by the administrator via the WEB management platform.

In addition, FIG. 5E and FIG. 5F show the information of the whitelist set by the administrator via the WEB management platform and information set by other rules. This embodiment is just exemplary and does not define a specific setting mode and the setting content, which may be set according to actual needs.

Thereby, in the wireless network detecting system in this embodiment, the server interacts with the wireless network sensor, which may monitor wireless access node information in a wireless network within an enterprise in real time and effectively ensure the security of the wireless network within the enterprise.

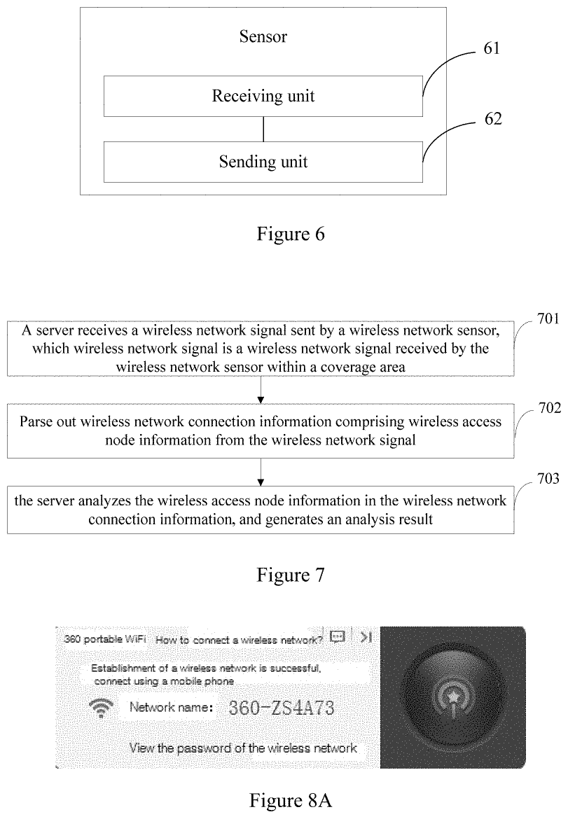

FIG. 6 shows a structure diagram of a wireless network sensor provided by an embodiment of the invention. As shown in FIG. 6, the wireless network sensor in the embodiment comprises at least a receiving unit 61 and a sending unit 62;

wherein the receiving unit 61 is configured to receive a wireless network signal within a coverage area; the sending unit 62 is configured to send the received wireless network signal to a server, such that the sever parses out wireless network connection information from the wireless network signal and analyzes wireless network access node information in the wireless network connection information.

Optionally, the sending unit 62 is specifically configured to send the received wireless network signal and location information of the wireless network sensor to the server, such that the sever parses out wireless network connection information from the wireless network signal and analyzes wireless network access node information in the wireless network connection information according to the location information;

wherein the location information of the wireless network sensor is location information preset in the wireless network sensor.

In an optional implementation, the receiving unit 61 is further configured to receive instruction information for blocking all clients which are connected to the wireless access node in the wireless access node information, when the server determines that the received wireless access node information is not secure.

The wireless access node information in the embodiment may comprise a wireless access node name, a wireless access node identifier, a wireless access node manufacturer, an SSID, a wireless access node encryption mode, a wireless access node authentication mode, whether authentication is turned on, whether the WPS function is turned off, a wireless access node channel, wireless access node latest discovery time, and information of a client connected to the wireless access node, etc.

The information of a client may comprise: a client identifier, a client manufacturer, a client number, time when a client is last connected to a wireless access node, and a list of wireless access nodes to which the client was connected, and so on.

In addition, the wireless network sensor shown in FIG. 6 may further comprise a blocking unit 63 not shown in the figure; and the blocking unit 63 is configured to block connections of the wireless access node and all the clients of the wireless access node according to the instruction information received by the receiving unit 61, which instruction information may be instruction information sent by the server.

In the embodiment, the wireless network sensor interacts with the server, which can ensure the security of a wireless network within an enterprise.

FIG. 7 shows a flow diagram of a wireless access node detecting method provided by a further embodiment of the invention. As shown in FIG. 7, the wireless access node detecting method of the embodiment comprises at least steps 701-703.

At 701, a server receiving a wireless network signal sent by a wireless network sensor, of which the wireless network signal is a wireless network signal received by the wireless network sensor within a coverage area.

At 702, wireless network connection information comprising wireless access node information is parsed out from the wireless network signal.

As an example, the wireless access node information may comprise a wireless access node identifier, and may further comprise a wireless access node name, a wireless access node identifier, a wireless access node channel, wireless access node discovery time, information of a client connected to the wireless access node, a wireless access node encryption mode, an SSID, whether encrypted and/or an authentication mode, etc.

At 703, the server analyzing the wireless access node information in the wireless network connection information, and generating an analysis result.

As an example, that the server analyzing the wireless access node information in the wireless network connection information may comprise: the server analyzing the wireless access node information in the wireless network connection information according to a preset black-/white-list rule, wherein the wireless access node information comprises information of a wireless access node once connected by a client, and information of a wireless access node which belongs to a preset blacklist/whitelist in the server, etc.

In a practical application, the server determines whether a wireless access node corresponding to the wireless access node identifier belongs to nodes in the preset whitelist.

If the wireless access node corresponding to the wireless access node identifier belongs to whitelist wireless access nodes, it may be determined that the wireless access node is a trusted wireless access node, and if it does not belong to the whitelist wireless access nodes, then it may be considered that the wireless access node is a blacklist wireless access node.

Optionally, if the wireless access node belongs to the whitelist wireless access nodes, the server may further view and analyze related information of the wireless access node, such as the wireless access node name, the encryption mode, the wireless access node manufacturer, the wireless access node authentication mode, and determine information such as the danger coefficient/security level of the wireless access node, etc. If the wireless access node belongs to blacklist wireless access nodes, the server also needs to analyze the related information of the wireless access node, determine the track and use frequency, etc. of the wireless access node, conduct real-time monitoring, and ensure the security of a wireless network of an enterprise.

For example, the server may conduct a security assessment to wireless access node information belonging to the preset whitelist according to a preset risk assessment mechanism, and determine the security level of a wireless access node corresponding to the wireless access node information, and send alarm information to a wireless access node of which the security level is below a preset security level, for example, send alarm information to a third-party server/terminal where the administrator resides, or send alarm information to a third-party server/terminal where a wireless access node corresponding to the wireless access node identifier is located, or send alarm information to a third-party server/terminal where the administrator resides using an e-mail/short message, or send alarm information to a third-party server/terminal where a wireless access node corresponding to the wireless access node identifier is located using an e-mail/short message.

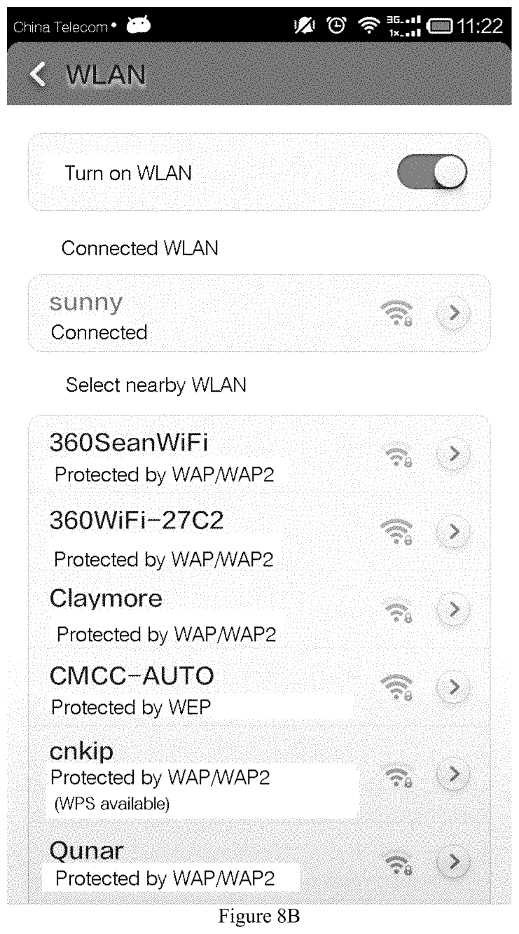

As an example, with reference to FIG. 8A and FIG. 8B, FIG. 8A shows a wireless access node established privately by an enterprise employee, and FIG. 8B shows WLAN wireless access nodes searched out by a mobile terminal of an enterprise employee within the enterprise, which WLAN wireless access nodes all belong to wireless access nodes established privately by employees within the enterprise. Thereby, the wireless network sensor monitors a wireless network signal comprising information of the WLAN wireless access nodes, and sends the monitored wireless network signal to the server; and the server may determine whether the WLAN wireless access nodes in the wireless network signal are secure according to the preset whitelist, and may further determine whether to block clients connected to the WLAN wireless access nodes, or the like.

Therefore, the server in the embodiment can effectively monitor a wireless network inside an enterprise, can analyze the state of the wireless network in real time, and may ensure the secure use of the wireless network within the enterprise.

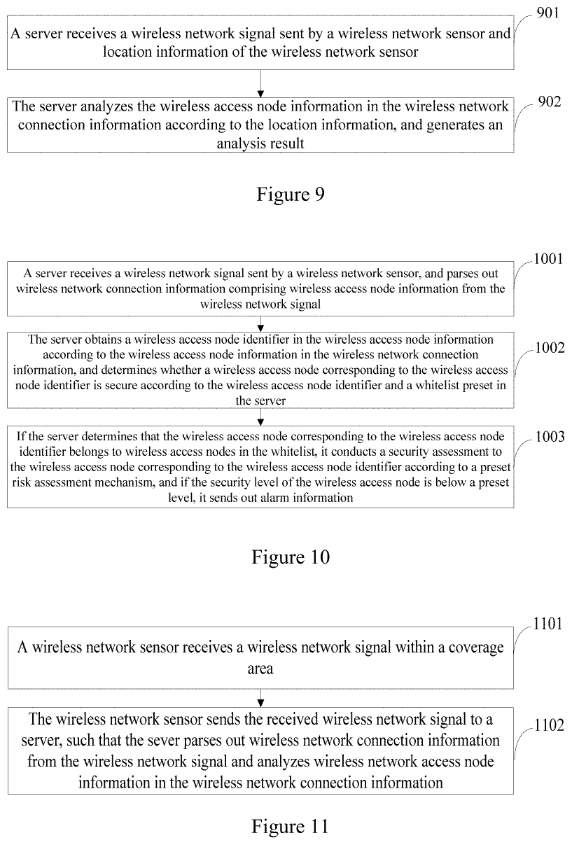

FIG. 9 shows a flow diagram of a wireless access node detecting method provided by a further embodiment of the invention. As shown in FIG. 9, the wireless access node detecting method of this embodiment comprises at least steps 901-902.

At 901, a server receiving a wireless network signal sent by a wireless network sensor and location information of the wireless network sensor, wherein the location information of the wireless network sensor is location information preset in the wireless network sensor.

At 902, the server analyzing the wireless access node information in the wireless network connection information according to the location information, and generating an analysis result.

The wireless access node information in the embodiment may comprise a wireless access node identifier, and may further comprise a wireless access node name, a wireless access node identifier, a wireless access node channel, wireless access node discovery time, information of a client connected to the wireless access node, a wireless access node encryption mode, an SSID, whether encrypted and/or an authentication mode, etc.

In a specific application, step 902 may specifically be as follows. The server obtaining a wireless access node identifier in the wireless access node information according to the wireless access node information, and determining whether a wireless access node corresponding to the wireless access node identifier is secure according to the wireless access node identifier and a blacklist/whitelist rule preset in the server.

Further, if the server determines that the wireless access node corresponding to the wireless access node identifier does not belong to the preset whitelist, it sends to the wireless network sensor instruction information for blocking all clients connected to the wireless access node, such that the wireless network sensor blocks connections of the wireless access node and all the clients of the wireless access node according to the instruction information.

In addition, if the server determines that the wireless access node corresponding to the wireless access node identifier does not belong to the whitelist wireless access nodes, it sends to a third-party server to which the wireless access node belongs instruction information for turning off the wireless access node, such that the third-party server turns off the wireless access node.

It may be noted that the third-party server may be a managed server/client connected to the server within an enterprise, and the third-party server is a server which is physically connected with the wireless access node.

In a specific application, if the server determines that the wireless access node corresponding to the wireless access node identifier does not belong to the whitelist wireless access nodes, it may further send alarm information. For example, it may send alarm information to a third-party server/terminal where the administrator resides, or send alarm information to a third-party server/terminal where a wireless access node corresponding to the wireless access node identifier is located, or send alarm information to a third-party server/terminal where the administrator resides using an e-mail/short message, or send alarm information to a third-party server/terminal where a wireless access node corresponding to the wireless access node identifier is located using an e-mail/short message.

In such a way, the secure use of an enterprise network can be effectively ensured, at the same time, various wireless access nodes can be monitored, and connections of various wireless access nodes with clients with wireless network cards are effectively prevented.

FIG. 10 shows a flow diagram of a wireless access node detecting method provided by a further embodiment of the invention. As shown in FIG. 10, the wireless access node detecting method of this embodiment comprises at least steps 1001-1003.

At 1001, a server receives a wireless network signal sent by a wireless network sensor, and parses out wireless network connection information comprising wireless access node information from the wireless network signal, of which the wireless network signal is a signal within a coverage area monitored by the wireless network sensor.

At 1002, the server obtains a wireless access node identifier in the wireless access node information according to the wireless access node information in the wireless network connection information, and determines whether a wireless access node corresponding to the wireless access node identifier is secure according to the wireless access node identifier and a whitelist preset in the server.

At 1003, if the server determines that the wireless access node corresponding to the wireless access node identifier belongs to wireless access nodes in the whitelist, it conducts a security assessment to the wireless access node corresponding to the wireless access node identifier according to a preset risk assessment mechanism, and if the security level of the wireless access node is below a preset level, it sends alarm information.

For example, it sends alarm information to a third-party server/terminal where the administrator resides, or sends alarm information to a third-party server/terminal where the wireless access node corresponding to the wireless access node identifier is located, or sends alarm information to a third-party server/terminal where the administrator resides using an e-mail/short message, or sends alarm information to a third-party server/terminal where the wireless access node corresponding to the wireless access node identifier is located using an e-mail/short message.

As an example, the conducting a security assessment to the wireless access node corresponding to the wireless access node identifier according to a preset risk assessment mechanism in step 1003 may specifically determining the level that the wireless access node belongs to according to the following exemplary table 1, and then determining the security level of the trusted wireless access node.

TABLE 1

| WIFI | | Whether | Whether | | Whether | Whether | |
|---|---|---|---|---|---|---|---|
| wireless | | QSS is | there is | Wireless | WPS is | Radius | |
| access node | Encryption | turned | a weak | access node | turned | authentication | Security |
| name | mode | off | password | manufacturer | off | is turned on | level |
| sunny | WPA | Yes | Yes | Xiaomi | Yes | No | High-risk |
| 360SeanWiFi | WPA | Yes | Yes | Qihoo | Yes | No | High-risk |
| CMCC- | WEP | Yes | Yes | — | No | Yes | Low-risk |
| AUTO | | | | | | | |

It should be noted that in a specific implementation, a security assessment may further be conducted on the wireless access node corresponding to the wireless access node identifier by other risk assessment mechanism, e.g., the content shown for the assessment of the security level/risk level as shown in FIG. 5A and FIG. 5B, and the embodiment only exemplifies a risk assessment mechanism and does not define it.

The server in the embodiment can discover wireless access nodes established privately by employees in an enterprise, and can analyze whether the wireless access nodes are trusted wireless access nodes, further determine the security level of a trusted wireless access node, and then may better protect a wireless network within the enterprise.

In addition, it needs to be noted that, while the server as shown in FIG. 7, FIG. 9 and FIG. 10 receives a wireless network signal sent by a wireless network sensor, it further receives the location information of the sensor sent by the wireless network sensor.

In a specific application, the server may determine a location which the wireless access node information belongs to according to the location information of the wireless network sensor, and then according to the location which the wireless access node information belongs to, the wireless access node identifier in the wireless access node information and the preset whitelist, determine whether the wireless access node corresponding to the wireless access node identifier is secure.

Since each enterprise has its particularity, the security levels of various areas/subsidiaries of different enterprises may be different, and therefore the security levels of a subsidiary located in an area A of Beijing and a subsidiary located in an area B of Beijing may be different, and in view of this, whitelists corresponding to different areas may be different. So, before judging a wireless access node, it is necessary to determine information of the area/location which the wireless access node belongs to, so as to relatively correctly analyze the wireless access node and ensure the security of a wireless network within an enterprise.

Optionally, in a further optional implementation scenario, a further wireless access node detecting method may be as shown in FIG. 11. The wireless access node detecting method shown in FIG. 11 comprises at least steps 1101-1102.

At 1101, a wireless network sensor receives a wireless network signal within a coverage area.

At 1102, the wireless network sensor sends the received wireless network signal to a server, such that the sever parses out wireless network connection information from the wireless network signal and analyzes wireless network access node information in the wireless network connection information.

As an example, it may further be possible to send the received wireless network signal and location information of the wireless network sensor to the server, such that the sever parses out wireless network connection information from the wireless network signal and analyzes wireless network access node information in the wireless network connection information according to the location information, wherein the location information of the wireless network sensor is location information preset in the wireless network sensor.

The wireless access node information may comprise one or more of a wireless access node name, a wireless access node identifier, e.g., MAC address, a wireless access node channel, wireless access node discovery time, information of a client connected to the wireless access node, a wireless access node encryption mode, an SSID, whether encrypted and/or an authentication mode.

In a specific application, the above method further comprises steps not shown in FIG. 11:

At 1103, the wireless network sensor receives instruction information for blocking all clients connected to the wireless access node in the wireless access node information, when the server determines that the received wireless access node information is not secure; and

At 1104, the wireless network sensor blocks connections of the wireless access node and all the clients of the wireless access node according to the instruction information.

In other embodiments, the wireless network sensor may further send the instruction information to a wireless access node within a monitoring range, such that the wireless access node blocks connections with all clients of the wireless access node.

The wireless network sensor in the embodiment is mainly configured to monitor a surrounding wireless access node signal. In other embodiments, the wireless network sensor is further configured to monitor broadcast information of a surrounding client, which may implement monitoring of wireless access nodes and clients, and ensure the network security of an enterprise.

In a practical application, the server further needs to locate a wireless access node, and then while sending the wireless access node information to the server, the wireless network sensor may send the location information of the wireless network sensor, so as to determine the location information of the wireless access node corresponding to the wireless access node identifier in the wireless access node information.

For example, the wireless network sensor may send the wireless network signal and the location information of the wireless network sensor to the server, such that the server determines the location (i.e., the location which the wireless access node information belongs to) of the wireless access node corresponding to the wireless access node identifier in the wireless access node information according to the location information of the wireless network sensor, and conducts security analysis on the wireless access node according to the location of the wireless access node and the wireless access node information in the wireless network signal.

In the embodiment, the wireless network sensor interacts with the server, which can effectively help a manager learn about the internal condition of a wireless network and provide the basis for decision-making of wireless network security construction for the manager.

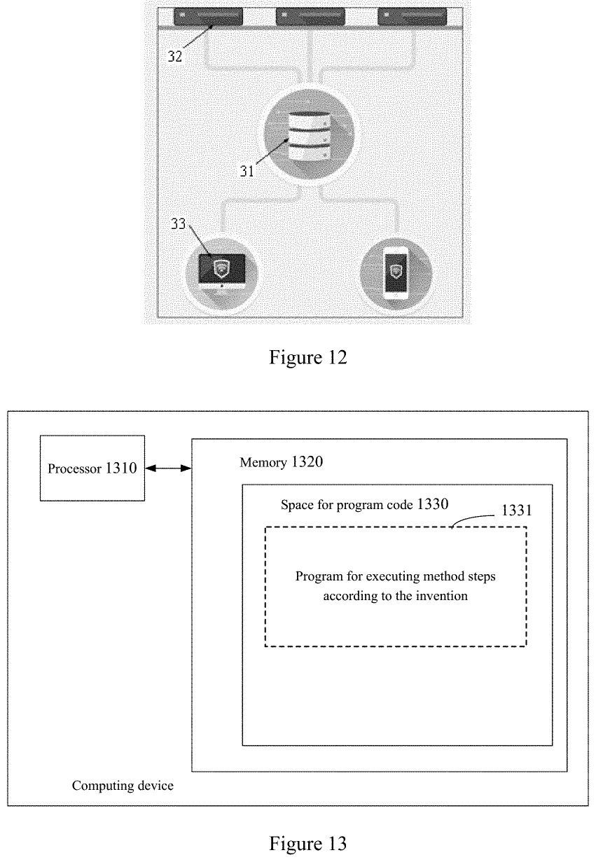

FIG. 12 shows a structure diagram of a wireless network detecting system provided by an embodiment of the invention. As shown in FIG. 3 and FIG. 12, the wireless network detecting system in the embodiment of the invention at least comprises at least one wireless network sensor 32 and a server 31.

The at least one wireless network sensor 32 is configured to receive a wireless network signal within its coverage area, wherein at least one wireless network card is built in the wireless network sensor, and the server 31 is coupled to the wireless network sensor 32 and configured to receive a wireless network signal from the wireless network sensor and parse out wireless network connection information from the wireless network signal, wherein the wireless network connection information comprises information of a wireless access node, wherein the server is further configured to conduct analysis on the wireless access node and generating an analysis result.

Therein, the wireless network sensor 32 is a sensor with a built-in wireless network card, and the wireless network sensor 32 is configured to monitor broadcast information sent by a client(s) 35 and/or a wireless network signal(s) comprising wireless access node information sent by a wireless access node(s) 34 within the coverage area in real time or regularly, or configured to obtain/monitor wireless data sent by the client(s)/wireless access node(s), or the like. As an example, the wireless network sensor 32 in the wireless access node detecting method can discover detailed information of all the wireless access nodes and clients in an environment where the current wireless network sensor is located, for example, an SSID, a MAC address, an encryption type, a channel, signal intensity, discovery time, the MAC address of a client, etc.

As shown in FIG. 12, the server 31 may be a central control server, connected with multiple wireless network sensors, and may communicate with each of the wireless network sensors 32. The server 31 may be configured to manage clients 35 and/or wireless access nodes 34 monitored by the wireless network sensors, for example, receiving a wireless network signal sent by a wireless network sensor, analyzing a wireless access node according to a preset black-/white-list rule, and then determining whether a network within an enterprise is secure. The wireless access node may be a wireless access node once connected by a client in the wireless network connection information, or the wireless access node is a wireless access node which occurs in the wireless network connection information and belongs to a preset blacklist/whitelist in the server.

The server is further configured to conduct a security assessment on a wireless access node belonging to the preset whitelist according to a preset risk assessment mechanism, determine the security level of the wireless access node, and send alarm information to a wireless access node of which the security level is below a preset security level.

The embodiment only exemplifies part of functions of the server 31, and does not define other functions of the server 31.

The wireless network detecting system in the embodiment may deploy wireless network sensors over an enterprise network, capture and analyze wireless network packets of all clients/wireless access nodes in real time, discover whether there is an attack behavior and discover whether there is a privately established wireless access node when an employee is not allowed to establish a wireless access node, and thereby ensure the secure use of the enterprise network.

In addition, the administrator may deploy sensors within the enterprise in advance by a WEB management platform 33 which is connected to the server. For example, multiple monitoring areas may be given inside the enterprise, and each of the monitoring areas is arranged with multiple wireless network sensors 32 to accomplish monitoring of clients and/or wireless access nodes in the area. When the wireless network sensors 32 are deployed, the device information of each wireless network sensor is recorded in the server, and the administrator may add, delete, modify or set the device information or other property such as the monitoring range, etc. of a wireless network sensor via the WEB management platform 33.

In a specific application, the administrator may set via the WEB management platform 33 a whitelist/blacklist of clients 35, or whitelist wireless access nodes/blacklist wireless access nodes of wireless access nodes, etc., such that the server monitors a client 35 according to the whitelist/blacklist. Or, the administrator may set via the WEB management platform 33 security rules in use of the wireless network of the enterprise, in order that the server may monitor a client 35 according to the set security rules. In addition, the administrator may determine via the WEB management platform whether a wireless access node in a list of wireless access nodes in the server is in the whitelist, and display the analysis result of the wireless access node information in the server. In a practical application, the administrator may, via the WEB management platform, configure the server's warning mode and/or add a user who may access the management platform and the access permissions of the user, and so on.

In addition, the wireless network detecting system shown in FIG. 12 may further comprise multiple terminals which are connected to the server. These terminals may log in the WEB management platform to implement monitoring of the network security in the enterprise. Or, these terminals may receive alarm information or a security alarm, etc. sent by the server. For example, the administrator logs in the WEB management platform via a terminal to set the whitelist/blacklist, etc. in the server.

The terminal is connected to the server for the alarm information sent by the server, and the terminal is configured to log in the server to view the analysis result, and/or receive the analysis result sent by the server or the alarm information that the security level of a wireless access node in the whitelist is below the preset security level.

The mobile terminal mainly comprises any device capable of wireless fidelity, such as a mobile phone, a computer, a tablet, a smart television, etc., and the invention will not specifically define the mobile terminal.

The wireless network detecting system can send alarm information to the administrator when the wireless network within the enterprise is attacked (e.g., AP spoofing, abnormal frequency changing of a wireless access node, wireless cracking), so as to block the authentication or connection between a wireless access node and a client via a wireless network sensor.

The server 31 stores wireless access node information in a wireless network signal sent by a wireless network sensor 32, and then may be configured to regularly conduct statistics and analysis on the wireless access node information sent by the wireless network sensor, and obtain the analysis result and/or send the analysis result to the WEB management platform.

The wireless network sensor 32 refers to a hardware sensor deployed internally in an enterprise, etc., and is configured to probe and block a WIFI wireless access node. As an example, the wireless access node information monitored by the wireless network sensor may comprise one or more of a wireless access node name, a wireless access node identifier, a wireless access node channel, wireless access node discovery time, information of a client connected to the wireless access node, a wireless access node encryption mode, an SSID, whether encrypted and/or an authentication mode.

Therein, the information of a client comprises: a client identifier, a client manufacturer, a client number, time when a client is last connected to a wireless access node, and a list of wireless access nodes to which the client was connected.

The wireless network detecting system of the embodiment of the invention may effectively assess the security of a wireless access node, i.e., the attack vulnerability, block a non-whitelist wireless access node, and monitor the behavior of a wireless access node, and achieve a comprehensive defense of the security of a wireless network of an enterprise.

In the specification provided herein, a plenty of particular details are described. However, it can be appreciated that an embodiment of the invention may be practiced without these particular details. In some embodiments, well known methods, structures and technologies are not illustrated in detail so as not to obscure the understanding of the specification.

Similarly, it shall be appreciated that in order to simplify the disclosure and help the understanding of one or more of all the inventive aspects, in the above description of the exemplary embodiments of the invention, sometimes individual features of the invention are grouped together into a single embodiment, figure or the description thereof. However, the disclosed methods should not be construed as reflecting the following intention, namely, the claimed invention claims more features than those explicitly recited in each claim. More precisely, as reflected in the following claims, an aspect of the invention lies in being less than all the features of individual embodiments disclosed previously. Therefore, the claims complying with a particular implementation are hereby incorporated into the particular implementation, wherein each claim itself acts as an individual embodiment of the invention.

It may be appreciated to those skilled in the art that modules in a device in an embodiment may be changed adaptively and arranged in one or more device different from the embodiment. Modules or units or assemblies may be combined into one module or unit or assembly, and additionally, they may be divided into multiple sub-modules or sub-units or subassemblies. Except that at least some of such features and/or procedures or units are mutually exclusive, all the features disclosed in the specification (including the accompanying claims, abstract and drawings) and all the procedures or units of any method or device disclosed as such may be combined employing any combination. Unless explicitly stated otherwise, each feature disclosed in the specification (including the accompanying claims, abstract and drawings) may be replaced by an alternative feature providing an identical, equal or similar objective.

Furthermore, it can be appreciated to the skilled in the art that although some embodiments described herein comprise some features and not other features comprised in other embodiment, a combination of features of different embodiments is indicative of being within the scope of the invention and forming a different embodiment. For example, in the following claims, any one of the claimed embodiments may be used in any combination.

Embodiments of the individual components of the invention may be implemented in hardware, or in a software module running on one or more processors, or in a combination thereof. It will be appreciated by those skilled in the art that, in practice, some or all of the functions of some or all of the components in a wireless access node detecting device according to individual embodiments of the invention may be realized using a microprocessor or a digital signal processor (DSP). The invention may also be implemented as a device or apparatus program (e.g., a computer program and a computer program product) for carrying out a part or all of the method as described herein. Such a program implementing the invention may be stored on a computer readable medium, or may be in the form of one or more signals. Such a signal may be obtained by downloading it from an Internet website, or provided on a carrier signal, or provided in any other form.

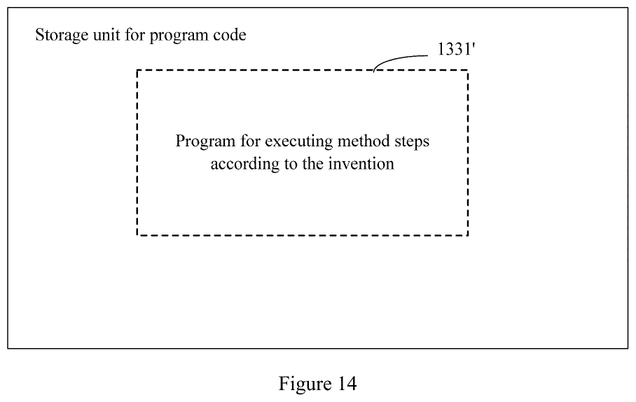

For example, FIG. 13 shows a computing device which may carry out a wireless access node detecting method according to the invention. The computing device traditionally comprises a processor 1310 and a computer program product or a computer readable medium in the form of a memory 1320. The memory 1320 may be an electronic memory such as a flash memory, an EEPROM (electrically erasable programmable read-only memory), an EPROM, a hard disk or a ROM. The memory 1320 has a memory space 1330 for a program code 1331 for carrying out any method steps in the methods as described above. For example, the memory space 1330 for a program code may comprise individual program codes 1331 for carrying out individual steps in the above methods, respectively. The program codes may be read out from or written to one or more computer program products. These computer program products comprise such a program code carrier as a hard disk, a compact disk (CD), a memory card or a floppy disk. Such a computer program product is generally a portable or stationary storage unit as described with reference to FIG. 14. The storage unit may have a memory segment, a memory space, etc. arranged similarly to the memory 1320 in the computing device of FIG. 13. The program code may for example be compressed in an appropriate form. In general, the storage unit comprises a computer readable code 1331′, i.e., a code which may be read by e.g., a processor such as 1310, and when run by a computing device, the codes cause the computing device to carry out individual steps in the methods described above.

“An embodiment”, “the embodiment” or “one or more embodiments” mentioned herein implies that a particular feature, structure or characteristic described in connection with an embodiment is included in at least one embodiment of the invention. In addition, it is to be noted that, examples of a phrase “in an embodiment” herein do not necessarily all refer to one and the same embodiment.

It is to be noted that the above embodiments illustrate rather than limit the invention, and those skilled in the art may design alternative embodiments without departing the scope of the appended claims. In the claims, any reference sign placed between the parentheses shall not be construed as limiting to a claim. The word “comprise” does not exclude the presence of an element or a step not listed in a claim. The word “a” or “an” preceding an element does not exclude the presence of a plurality of such elements. The invention may be implemented by means of a hardware comprising several distinct elements and by means of a suitably programmed computer. In a unit claim enumerating several apparatuses, several of the apparatuses may be embodied by one and the same hardware item. Use of the words first, second, and third, etc. does not mean any ordering. Such words may be construed as naming.

Furthermore, it is also to be noted that the language used in the description is selected mainly for the purpose of readability and teaching, but not selected for explaining or defining the subject matter of the invention. Therefore, for those of ordinary skills in the art, many modifications and variations are apparent without departing the scope and spirit of the appended claims. For the scope of the invention, the disclosure of the invention is illustrative, but not limiting, and the scope of the invention is defined by the appended claims.

1. A server comprising:
a receiving unit configured to receive a wireless network signal sent by a wireless network sensor, wherein the wireless network signal is a wireless network signal received by the wireless network sensor within a coverage area;
a parsing unit configured to parse out wireless network connection information comprising wireless access node information from the wireless network signal; and
an analyzing unit configured to analyze the wireless access node information in the wireless network connection information, and generate an analysis result.

2. The server as claimed in claim 1, wherein the receiving unit is further configured to
receive the wireless network signal sent by the wireless network sensor and location information of the wireless network sensor;
wherein the location information of the wireless network sensor is location information preset in the wireless network sensor; and
the analyzing unit is further configured to
analyze the wireless access node information in the wireless network connection information according to the location information, and generate an analysis result

3. The server as claimed in claim 1, wherein the analyzing unit is further configured to
analyze the wireless access node information in the wireless network connection information according to a preset black-/white-list rule;
wherein the wireless access node information comprises information of a wireless access node once connected by a client, information of a wireless access node which belongs to a preset blacklist/whitelist in the server.

4. The server as claimed in claim 1, wherein the analyzing unit is further configured to
conduct a security assessment to wireless access node information belonging to a preset whitelist in the server according to a preset risk assessment mechanism, and determine a security level of a wireless access node corresponding to the wireless access node information.

5. The server as claimed in claim 4, wherein the server further comprises a sending unit, and
the sending unit is configured to send alarm information when the security level of the wireless access node assessed by the analyzing unit is below a preset security level.

6. The server as claimed in claim 5, wherein the sending unit is further configured to
send the alarm information to a third-party server/terminal where the administrator resides, or
send the alarm information to a third-party server/terminal where a wireless access node corresponding to the wireless access node identifier is located, or
send the alarm information to a third-party server/terminal where the administrator resides using an e-mail/short message, or
send the alarm information to a third-party server/terminal where a wireless access node corresponding to the wireless access node identifier is located using an e-mail/short message.

7. The server as claimed in claim 1, wherein
the wireless access node information further comprises one or more of the following:
a wireless access node name, a wireless access node identifier, a wireless access node channel, wireless access node discovery time, information of a client connected to the wireless access node, a wireless access node encryption mode, a service set identifier SSID, whether encrypted and an authentication mode.

8. The server as claimed in claim 7, wherein the information of a client comprises:
a client identifier, a client manufacturer, a client number, time when a client is last connected to a wireless access node, and a list of wireless access nodes to which the client was connected.

9. (canceled)

10. (canceled)

11. A wireless access node detecting method comprising:
a server receiving a wireless network signal sent by a wireless network sensor, wherein the wireless network signal is a wireless network signal received by the wireless network sensor within a coverage area;
parsing out wireless network connection information comprising wireless access node information from the wireless network signal; and
the server analyzing the wireless access node information in the wireless network connection information, and generating an analysis result.

12. The method as claimed in claim 11, wherein a server receiving a wireless network signal sent by a wireless network sensor comprises:
a server receiving a wireless network signal sent by a wireless network sensor and location information of the wireless network sensor,
wherein the location information of the wireless network sensor is location information preset in the wireless network sensor; and
correspondingly, the server analyzing the wireless access node information in the wireless network connection information comprises:
the server analyzing the wireless access node information in the wireless network connection information according to the location information, and generating an analysis result.

13. The method as claimed in claim 11, wherein the server analyzing the wireless access node information in the wireless network connection information comprises:
the server analyzing the wireless access node information in the wireless network connection information according to a preset black-/white-list rule,
wherein the wireless access node information comprises information of a wireless access node once connected by a client, information of a wireless access node which belongs to a preset blacklist/whitelist in the server.

14. The method as claimed in claim 11, wherein the server analyzing the wireless access node information in the wireless network connection information comprises:
the server conducting a security assessment to wireless access node information belonging to a preset whitelist according to a preset risk assessment mechanism, and determining a security level of a wireless access node corresponding to the wireless access node information, and
sending alarm information to a wireless access node of which the security level is below a preset security level

15. The method as claimed in claim 14, wherein the sending out alarm information comprises:
sending the alarm information to a third-party server/terminal where the administrator resides, or
sending the alarm information to a third-party server/terminal where a wireless access node corresponding to the wireless access node identifier is located, or
sending the alarm information to a third-party server/terminal where the administrator resides using an e-mail/short message, or
sending the alarm information to a third-party server/terminal where a wireless access node corresponding to the wireless access node identifier is located using an e-mail/short message.

16. The method as claimed in claim 11, wherein
the wireless access node information further comprises one or more of the following:
a wireless access node name, a wireless access node identifier, a wireless access node channel, wireless access node discovery time, information of a client connected to the wireless access node, a wireless access node encryption mode, an SSID, whether encrypted and an authentication mode.

17. The method as claimed in claim 16, wherein the information of a client comprises:
a client identifier, a client manufacturer, a client number, time when a client is last connected to a wireless access node, and a list of wireless access nodes to which the client was connected.

18. (canceled)

19. (canceled)

20. A wireless network detecting system comprising:
at least one wireless network sensor configured to receive a wireless network signal within its coverage area, wherein at least one wireless network card is built in the wireless network sensor; and
a server coupled to the wireless network sensor and configured to receive a wireless network signal from the wireless network sensor and parse out wireless network connection information from the wireless network signal, wherein the wireless network connection information comprises information of a wireless access node;
wherein the server is further configured to conduct analysis to the wireless access node and generate an analysis result.

21. The system as claimed in claim 20, wherein that the server is further configured to conduct analysis on the wireless access node according to the information of the wireless access node and generate an analysis result comprises:
the server being configured to analyze the wireless access node according to a preset black-/white-list rule,
wherein the wireless access node is a wireless access node once connected by a client in the wireless network connection information, or the wireless access node is a wireless access node which occurs in the wireless network connection information and belongs to a preset blacklist/whitelist in the server.

22. The system as claimed in claim 20, wherein the server is further configured to
conduct a security assessment to a wireless access node belonging to a preset whitelist according to a preset risk assessment mechanism, determine a security level of the wireless access node, and
send alarm information to a wireless access node of which the security level is below a preset security level.

23. The system as claimed in claim 20, wherein the system further comprises:
a terminal which is connected with the server and configured to receive the alarm information sent by the server,
wherein the terminal is configured to log in the server to view the analysis result, and/or receive the analysis result or the alarm information sent by the server.

24. (canceled)

25. (canceled)
